(19) United States
(12) Patent Application Publication
(10) Pub. No.: US 2024/0017501 A1
(43) Pub. Date: Jan. 18, 2024

(54) Filament Connector

(71) Applicant: Filafuse GmbH, Nürnberg (DE)

(72) Inventor: Moritz Piltz, Nürnberg (DE)

(21) Appl. No.: 18/034,353

(22) PCT Filed: Oct. 28, 2021
(86) PCT No.: PCT/EP2021/080036

§ 371 Date: Apr. 27, 2023

(30) Foreign Application Priority Data
Oct. 29, 2020 (DE) 10 2020 128 485.3

(51) Int. Cl. B29C 65/28; B33Y 40/00; B29C 64/314

(52) U.S. Cl. CPC B29C 65/28; B33Y 40/00; B29C 64/314; B29C 64/118

(57) ABSTRACT

The invention relates to a filament connector for connecting respective ends (1, 2) of filaments (3, 4) for the additive manufacturing of a three-dimensional object in fused filament fabrication, the filament connector comprising: —at least two mold elements (5, 6) which can be put together; and—a filament negative mold (8) in which the ends (1, 2) of the filaments (3, 4), which ends have previously been melted in a melting region (24) of the filament connector, can be joined together by the solidification of the melt of the filament materials of the two ends (1, 2). The filament negative mold (8) forms the melting region of the filament connector; within the filament negative mold, the ends (1, 2) of the filaments (3, 4) can be melted by an input of heat and can be joined together by the solidification of the melt of the filament materials of the two ends (1, 2).

### CROSS-REFERENCE TO RELATED APPLICATIONS

This application is a U.S. national phase application filed under 35 U.S.C. § 371 of International Application No. PCT/EP2021/080036, filed Oct. 28, 2021, designating the United States, which claims priority from German patent application No. 10 2020 128 485.3, filed Oct. 29, 2020, both of which are hereby incorporated by reference herein in their entireties.

### FIELD

The invention relates to a filament connector for connecting respective ends of filaments for the additive manufacture of a three-dimensional object in a fused filament fabrication according to the preamble of claim 1.

### BACKGROUND

In additive manufacturing methods in the form of 3D printing methods, such filaments of meltable plastic are employed in the fused filament fabrication (FFF; in German: Schmelzschichtungsverfahren). Herein, particles of melted filament material are applied layer by layer by means of a 3D printer based on a raster, to obtain the desired three-dimensional model from the melted and subsequently again solidified filament material.

Also for experienced users, it is sometimes difficult to estimate if a filament reel or the like is sufficient for the upcoming print of a certain, three-dimensional object. Especially with larger objects, which have to be produced in a printing process of several hours, therefore, the user often tends to a precautious change of the filament, which is sufficient for the object to be printed with great probability. Not least hereby, larger amounts of filament residues potentially arise, which considerably impairs the economy of the method.

In order to remedy the described problems, a plurality of filament connectors are already known from the prior art, by means of which respective ends of meltable filaments can be connected to each other by melting and solidifying.

Thus, a filament connector is known from the prior art under the English name filament join or filament connector (retrievable on 21 Sep. 2020 under https.//www.aliexpress.com/i/32941125704.html), which comprises substantially two mold elements/mold halves capable of being assembled and separable from each other. Herein, one filament end is respectively slidable into the filament connector via openings opposite to each other until the two filament ends meet in the region of a central heating opening open to the outside. Therein, the one opening for the one filament end is formed by a bore within the filament connector, the other opening is formed by a filament negative mold of Teflon or the like. After the two filament ends have been brought into the region of the central opening, they can be heated and melted by means of an open flame. Then, the two filament ends can be connected to each other by pressing to each other in axial direction of the filaments and be commonly moved towards the filament negative mold, within which the solidification of the melted ends is effected. Herein, the filament negative mold of Teflon ensures that the filament ends connected to each other then form a now assembled filament, which is identical in cross-section to the regions of the filament not heated during the connecting method. Thus, a consistent cross-section is to be achieved by the filament negative mold such that complications within the 3D printer do not occur in the region of the joint in the subsequent 3D printing.

However, it is disadvantageous in the described filament connector that melting, subsequent connection of the filament ends and moving the melted filament ends from the central heating opening into the filament negative mold requires very much dexterity and is very prone to failure, respectively, such that the connection of the filament ends to a then continuous filament is not readily guaranteed. By heating the filament ends immediately with an open flame, the problem additionally arises that the filament ends discolor by the soot of the flame, which finally negatively influences the printing result of the three-dimensional object to be printed. By heating with open flame, vapors harmful to health can additionally be released.

A further filament connector (retrievable on 21 Sep. 2020 under: https.//www.heise.de/select/make/2017/6/1513988716514761.html) comprises respective, sleeve-like connecting elements, which are to be fitted onto the two ends of the filaments respectively to be connected. After both ends of the respective filaments have been heated with an open flame, they can be connected to each other by pressing the two sleeves together. The solidified joint can then be smoothed or be reduced in diameter to that of the remaining filament by rotating the two sleeves.

However, it is problematic herein that it requires very much practice and dexterity to arrive at a satisfactory result. Moreover, the two sleeves cannot be removed from the assembled filament, but only be shifted along it. This means that for example with a filament reel newly applied at the 3D printer, it has to be unwound to remove the two sleeves. In addition, an immediate heating of the filament ends with an open flame is required here too such that sooting or the like discoloration of the filament can occur here too. Herein too, vapors harmful to health can again be released by heating with open flame.

### SUMMARY

Therefore, it is the object of the present invention to provide a filament connector of the initially mentioned type, by means of which the respective ends of the filaments to be connected can be connected to each other in significantly more reliable and simpler manner.

According to the invention, this object is solved by a filament connector with the features of claim 1. Advantageous configurations with convenient developments of the invention are the subject matter of the dependent claims.

The filament connector according to the invention comprises at least two mold elements or mold halves capable of being assembled as well as a filament negative mold, in which the ends of the filaments previously melted in a melting region of the filament connector can be connected to each other by solidification of the melt of the filament materials of the two ends. In order to therein achieve a particularly simple and reliable connection of the two ends of the respective filaments, it is provided according to the invention that the filament negative mold forms the melting region of the filament connector, within which the ends of the filaments can be melted by heat input and the two ends can be connected to each other by solidification of the melt of the filament materials. In contrast to the previous prior art, accordingly, the respective ends of the filaments are positioned in the region of the filament negative mold, which then forms the melting region of the filament connector, already before heat input, in that this filament negative mold is correspondingly heated. Associated with the heating of the filament negative mold, therein, melting of the two filament ends arranged within the filament negative mold is effected. This can be effected for example by means of an external flame in simple manner. In contrast to the previous prior art, direct contact of the flame with the filament ends does not occur therein, but the filament negative mold is rather correspondingly heated, within which the filament ends are received. In another embodiment, it would also be conceivable to heat the filament negative mold by means of a heat cartridge or by means of a different heating element. Anyway, the filament negative mold is to form the melting region of the filament connector, in which the respective ends of the filaments to be connected are heated and melted, respectively, after positioning thereof. Solidification of the melted ends of the then integral filament is also effected in the filament negative mold such that a movement of the filaments to be connected is at least largely not required between melting and solidifying the melt of the filament materials in contrast to the prior art, but that everything is rather effected in situ—namely within the filament negative mold. Rather, only slight compression of the filament ends within the filament negative mold by few millimeters is required towards the end of the melting process to ensure a secure connection of the filament ends—but a movement of the filament ends into the filament negative mold or a movement of the mold parts of the filament connector is not required.

This allows not only a reliable connection of the respective ends of the filaments since excessive movements of the filaments during the connection are not required, but also an extremely stable connection of the ends of the filaments after solidification of the filament materials. In addition, it is ensured in simple manner within the filament negative mold that at least substantially no other cross-section is given to the newly created, integral filament in the region of the joint of the original ends of the filaments to be connected than in the remaining length regions of the then created new, integral filament. Rather, the filament negative mold is preferably matched in cross-section to the cross-section of the ends of the filaments to be connected such that that cross-section automatically results in the connection region upon solidification of the melt of the filament materials, which the filament also has in the remaining region.

Additionally, it is a further advantage of the filament connector according to the invention that colored filament can also be produced, which allows an individually designed order of the filament in color, portions and (total) length. Herein, the essential advantage of the filament connector is that attaching a new filament piece to a filament piece already located in the printer is optionally also possible, wherein the filament connector can again be removed after connecting the individual filaments.

In advantageous configuration of the invention, the filament negative mold is herein produced from metal material. Hereby, a particularly beneficial heat transfer upon applying an external flame or a particularly beneficial heat transfer in the employment of an internal heating cartridge or the like heating element can be provided on the one hand, the filament negative mold is thus particularly robust and simply manufacturable on the other hand. Further advantages are the heat resistance and the shape stability of the mold parts of the filament connector.

In further advantageous configuration of the invention, the filament negative mold is constituted of a plurality of mold parts, in particular of partial shells dividable in extension direction of the filament. Hereby, the filament negative mold can be particularly simply removed from the joint of the then integral filament manufactured from the two ends.

In further configuration of the invention, the mold elements of the filament connector can be assembled to each other by respective sliding guide elements. Hereby, a constructionally particularly simpler filament connector results. In this context, it has further proven advantageous if the respective sliding guide elements of the mold elements of the filament connector conically cooperate with each other in assembling. Herein, the sliding guide elements can in particular be conically or cylindrically or frustum-shaped formed. This means that the two mold elements of the filament connector are particularly beneficially positioned in relation to each other upon reaching a final position, to avoid inaccuracies between the two mold elements. In additional, the conically cooperating sliding guide elements of the mold elements of the filament connector allow the particularly simple finding and mutual introduction thereof.

A further advantageous configuration of the invention provides that the mold elements of the filament connector comprise respective fixing openings arranged at least in partial overlap with each other with assembled mold elements, into which a securing means, in particular a filament section, can be inserted. Thus, the two mold elements are particularly simply fixable to each other in their mutual final position by means of the fixing opening.

In this context, it has further proven advantageous if respective centers of the fixing openings cooperating with each other in the corresponding mold elements have an offset to each other. Hereby, a particularly beneficial clamping effect between the respective fixing openings within the two mold elements can be achieved. In addition, the possibility of readjusting in case of unbeneficial tolerance combinations arises to ensure a final resting of the mold elements or insert parts.

A further advantageous embodiment of the invention is characterized in that the mold elements and the associated mold part of the filament negative mold are respectively integrally formed. Hereby, the respective mold elements with the associated mold parts of the filament negative mold can be particularly simply produced.

A further advantageous embodiment provides that the filament negative mold is formed for heating by means of a flame. Herein, it is for example conceivable to correspondingly coat at least the filament negative mold, for example by means of a chromium oxide layer, in order that the optical appearance of the filament connector remains unchanged even after many applications. Such a coating or such a construction in particular has the advantage of a particularly good heat resistance and is safe for health upon contact with a flame. In addition, a decrease of the corrosion resistance can be avoided and a very thin layer thickness can be realized. A further great advantage of such a coating is that an extremely smooth surface can be realized especially in the region of the filament negative mold, which in particular contributes to the fact that the respective filament 3, 4 does not adhere to the respective mold element 5, 6 in this region.

Furthermore, it has proven advantageous if the filament negative mold is formed as an insert part exchangeable in the filament connector. Hereby, it is for example possible to employ different filament negative molds for different diameters of filaments.

In a further advantageous embodiment of the invention, the respective mold element comprises respective stud-like sliding guide elements, which protrude with respect to a separating surface towards the respective other mold element, in which stud receptacles for receiving the stud-like sliding guide elements are recessed. By such stud-like sliding guide elements extending transversely to the separating plane or to the respective wide side of the mold elements, and associated stud receptacles, the mold elements or mold halves can be particularly simply assembled or separated in transverse direction of the separating plane, wherein the sliding guide elements and associated stud receptacles serve as stops and guides for mutual positioning of the mold elements.

Therein, it has proven advantageous in further configuration of the invention if the respective sliding guide elements and the respective stud receptacles of the mold elements comprise respective guide and stop surfaces, along which the mold elements can be positioned in relation to each other. Preferably, the respective guide and stop surfaces cooperating with each other extend substantially perpendicularly to the separating plane or wide side of the two mold elements to hereby achieve a geometrically particularly accurate and simple mutual guidance of the mold elements.

In a particularly advantageous embodiment of the invention, respective receiving openings for fixing means extending transversely to the separating surface of the mold elements for mutually fixing the mold elements, in which magnetic elements or mechanical connecting elements are arranged, are introduced into the respective mold elements. Accordingly, if the two mold elements are assembled by means of the stud-like sliding guide elements and the associated stud receptacles, thus, the mold elements can be particularly simply mutually fixed by means of the fixing means arranged in the receiving openings. Herein, respective magnetic elements are in particular arranged in the receiving openings to allow a particularly fast assembly and subsequent detachment of the mold elements. Alternatively, screw elements are for example also conceivable here, by which the mold elements can be screwed to each other. Hereby too, a fast and simple connection and detachment of the mold elements is possible.

In this context, the receiving openings of the respective mold element are introduced on opposite sides of the respectively associated groove in further configuration of the invention. Hereby, an optimum mutual fixing of the mold elements to each other arises on both sides of the groove.

Finally, it has proven advantageous if the basic shapes of the two mold halves are formed identical in shape. Therein, the configuration of the mold elements together with the respective sliding guide elements and the respective stud receptacles for example is to be understood by basic shape. This basic shape in particular allows a uniform casting mold and/or a uniform cutting processing of the mold elements. If required, only and in particular the receiving openings can be unsymmetrical or be arranged such that the mold halves differ from each other. However, these receiving openings can be simply introduced and allow a particularly beneficial fixing of the mold halves to each other with unsymmetric arrangement.

Further features of the invention are apparent from the claims, the figures and the description of figures. The features and feature combinations mentioned above in the description as well as the features and feature combinations mentioned below in the description of figures and/or shown in the figures alone are usable not only in the respectively specified combination, but also in other combinations or alone.

### BRIEF DESCRIPTION OF THE DRAWINGS

FIG. 1 a perspective view to a first embodiment of the filament connector according to the invention with two assembled mold elements or mold halves, which commonly form a filament negative mold for receiving respective ends of filaments;

FIGS. 2a-2c respective perspective views to one of the two mold elements or mold halves of the filament connector according to the first embodiment of the filament connector shown in FIG. 1, wherein it is in particular apparent that each mold element or each mold half forms a partial shell of the filament negative mold divided in extension direction of the filament, as well as a schematic sectional view through the mold elements or mold halves of the filament connector connected to each other according to the first embodiment shown in FIG. 1 in the region of respective fixing openings at least partially arranged in overlap with each other, the centers of which presently have an offset to each other;

FIGS. 3a, 3b a perspective view as well as a side view to the filament connector according to the first embodiment with inserted respective ends of filaments, which are heated for melting in the region of the filament negative mold by an indicated heat source;

FIGS. 4a, 4b respective perspective views to one of the two mold elements or one of the mold halves of the filament connector according to a second and a third embodiment;

FIGS. 5a, 5b respective perspective views to one of the two mold elements and a filament connector, respectively, according to a fourth and a fifth embodiment;

FIG. 6 in perspective view, a mold half and a filament connector, respectively, according to a sixth embodiment;

FIG. 7 in perspective view, a mold half of a filament connector according to a seventh embodiment;

FIGS. 8a, 8b respective perspective views to a mold half of a filament connector according to an eighth and a ninth embodiment;

FIG. 9 respective perspective views to a corresponding mold half of filament connectors according to a tenth embodiment;

FIG. 10 respective perspective views to a filament negative mold of a filament connector according to an eleventh embodiment;

FIG. 11 a perspective view to a mold half of a filament connector according to a twelfth embodiment;

FIG. 12 a perspective view to a circularly formed mold half of a filament connector according to a further embodiment;

FIG. 13 a perspective view to a mold half of a filament connector according to a further embodiment, which can be selectively provided with a filament negative mold for a thicker or a thinner filament;

FIG. 14 a perspective view to a mold half and a filament connector, respectively, according to a further embodiment, in which the pipe body has a rectangular cross-section on all sides;

FIG. 15 respective perspective views to mold halves and a filament connector, respectively, according to a further embodiment, in which the sliding guides allow a dovetail-like guidance;

FIGS. 16a, 16b in perspective view, a mold half and both assembled mold halves of a filament connector, respectively, according to a further embodiment;

FIGS. 17a, 17b respective perspective views to two mold halves of a filament connector according to a further embodiment;

FIG. 18 a perspective view of the filament connector assembled from the two mold halves according to FIG. 17a and FIG. 17b;

FIG. 19 a perspective sectional view through the filament connector according to FIG. 18;

FIGS. 20a-20c two perspective views to a mold half and a further perspective view to a further mold half of a filament connector according to a further embodiment; and

FIG. 21 a perspective view of the filament connector assembled from the two mold halves according to FIG. 20a and FIG. 20b, respectively, as well as from FIG. 20c.

### DETAILED DESCRIPTION

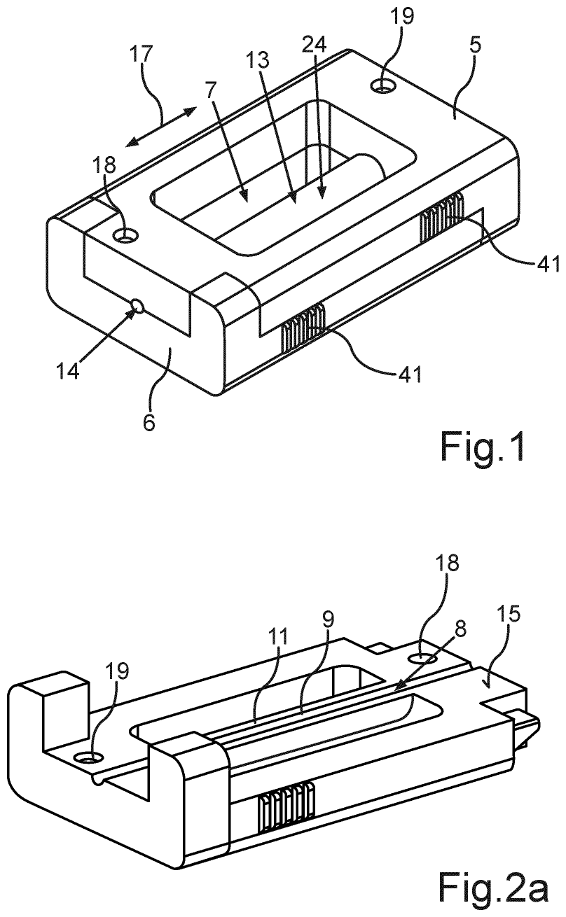

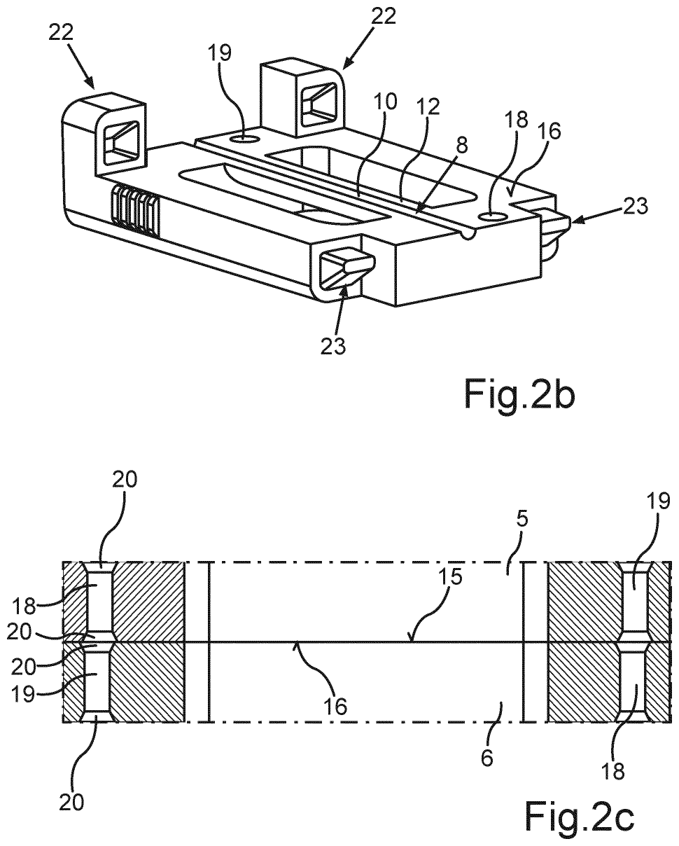

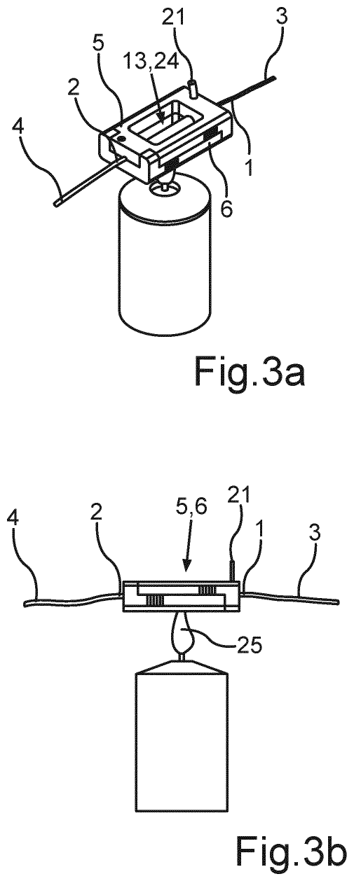

Of a filament connector for connecting respective ends 1, 2 of corresponding filaments 3, 4 apparent in FIGS. 3a and 3b for the additive manufacture of a three-dimensional object in a fused filament fabrication (FFF), respective mold elements or mold halves 5, 6 are illustrated in a perspective view in FIG. 1, which are shown separately from each other in respective perspective views in FIGS. 2a and 2b. Presently, the two mold halves 5, 6 are formed identical in shape such that they can advantageously be produced in only one mold. In the present case, the mold halves 5, 6 can in particular be produced from a stainless steel material in an investment casting method. Other materials, in particular metals, are also conceivable. Therein, other manufacturing methods, in particular cutting manufacturing methods, are also conceivable.

The mold halves 5, 6 have a respectively substantially rectangular basic contour, which surrounds a central opening 7. A filament negative mold 8 is formed within the mold elements 5, 6 in that a gutter-like groove 10 semicircular in cross-section is respectively formed. This groove 9 and 10, respectively, is formed in the region of the central opening 7 by a respective mold part in the form of a partial shell 11, 12 dividable in extension direction of the respective filament 3, 4, which is presently formed integrally with the respective mold element or the respective mold half 5, 6. Thus, the two partial shells 11, 12 are formed as respective half pipes, which have the opening formed as the groove 9 and 10, respectively, in the interior.

In the assembled state of the two mold halves 5, 6, the partial shells 11, 12 thus form a pipe body 13 apparent in FIG. 1, which is an essential part of the filament negative mold 8. For the rest, the filament negative mold is formed by those length regions of the respective grooves 9, 10, which extend to the respective partial shells 11, 12 to the outside up to the narrow sides of the respective mold elements or mold halves 5, 6.

Therein, it is apparent from FIG. 1 that the grooves 9, 10 thus complement each other to a channel 14 circular in cross-section, which forms the filament negative mold 8. Herein, the filament negative mold 8 is adapted in cross-section to the cross-section of the ends 1, 2 of the filaments 3, 4 respectively to be connected to each other. In particular, this means that the channel 14 or the filament negative mold 8 thus substantially has a cross-section of for example 1.75 millimeters or 2.85 millimeters, which represent the usual cross-sections of corresponding filaments for the 3D printing. Therein, the filament negative mold 8 can be formed slightly larger, for example about 1.8 millimeters or about 3 millimeters.

Furthermore, it is apparent from FIGS. 2 and 3 that respective sliding guide elements 22 and 23, respectively, protrude from the respective mold element 5, 6, which are presently formed at least substantially as a negative mold and positive mold, respectively, of a truncated cone. Therein, the sliding guide elements 22, 23 respectively arranged in pairs conically engage with each other in assembling or sliding the mold halves 5, 6 together, that is upon sliding the two mold halves 5, 6 together along a sliding direction illustrated in FIG. 1 (arrow 17), the sliding guide elements 22, 23 cause in the final position of the two mold halves 5, 6, which is indicated in FIG. 1, that they flatly rest on each other with their respective wide sides 15, 16. Thus, in the final position of the two mold halves 5, 6, the accurately fitting and tight abutment thereof to each other is achieved. By corrugations 40, 41 on the respective narrow sides of the mold halves 5, 6, the handling in sliding together or detaching the two mold halves is facilitated. Instead of the corrugations 40, 41, other handling locations can also be provided.

If this mutual relative position of the two mold halves 5, 6 analogously to FIG. 1 is reached, securing of the two mold halves 5, 6 in their mutual relative position can be achieved by means of respective fixing openings 18, 19 arranged at least in partial overlap with each other in each of the two mold halves 5, 6. Therein, each of the two mold halves 5, 6 comprises one fixing opening 18, 19, such that each one fixing opening 18 of the one mold half 5, 6 comes in overlap with a fixing opening 19 of the other mold half 5, 6 with completely assembled mold halves 5, 6. Herein, it is apparent from FIG. 2c that the fixing openings 18, 19 respectively corresponding to each other in each of the two mold halves 5, 6 can have an offset of their centers by for example 0.25 millimeters such that a fixing element extendable through the respective fixing openings 18, 19 always clamps or wedges the two mold halves 5, 6 to each other, even if unbeneficial tolerance combinations are given. Each of the fixing openings 18, 19 comprises—as it is apparent from FIG. 2c—respective chamfers 20, which facilitate introduction of the respective securing means. In particular a filament piece 21 can serve as the securing means, as it is for example indicated in FIGS. 3a and 3b. In the present case, the fixing openings 19 are formed slightly larger in diameter than the fixing openings 18. For example, the fixing openings 19 have a diameter of about 2 millimeters and the fixing openings 18 have a diameter of about 1.8 millimeters. Hereby, a corresponding securing means, for example a filament piece 21, which in particular has a diameter of 1.75 millimeters in the present case with the indicated diameters of the fixing openings 18, 19, can for example be first guided into the smaller fixing openings 18 in its insertion direction and then further through the larger fixing openings 19. By the fixing opening 19 with larger diameter adjoining to the fixing openings 18 with smaller diameter in insertion direction, thus, insertion of the securing means/filament piece 21 without complication can be ensured. It is clear that the fixing openings 18, 19 can also have other diameters. If the filament connector is for example employed for connecting respective filament ends with a diameter of 2.85 millimeters, and if filament pieces of this diameter therein are to serve as securing means insertable into the fixing openings, thus, the fixing openings correspondingly have other diameters. However, each one of the cooperating fixing openings is then also preferably formed larger in diameter than the other one.

Therein, the connection of the respective ends 1, 2 of the corresponding filaments 3, 4 is effected as follows:

Preferably, the two mold halves 5, 6 are first connected to each other in that they are for example displaced or shifted with respect to each other along the direction of the arrow 17 by means of the sliding guide elements 22, 23 until they have reached their mutual final position or in particular the two wide sides 15, 16 extensively abut on top of each other. Hereby, the filament negative mold 8 formed by the grooves 9, 10 is closed. Then, the mold halves 5, 6 can be secured in their mutual relative position by inserting the filament piece 21 into the corresponding fixing openings 18, 19. After the thus performed closure of the filament connector, the two ends 1, 2 of the corresponding filaments 3, 4 can then be introduced into the corresponding channel 14 formed by the grooves 9 and 10 from both sides, until they come into contact with each other in the region of the pipe body 13. Preferably, this contact is to be effected approximately in the center of the pipe body 13 of the filament negative mold 8. In order to facilitate the introduction of the two filament ends 1, 2 into the channel 14, it can have a slight excess in diameter with respect to the cross-section of the filaments 3, 4. With filaments 3, 4 with a diameter of 1.75 millimeters, the channel can for example have a diameter of 1.8 millimeters.

Alternatively to this positioning, it would theoretically also be conceivable to insert the two ends 1, 2 of the filaments 3, 4 to be connected to each other for example into one of the two mold halves 5 or 6 into the corresponding groove 9 or 10, namely preferably such that the ends 1, 2 contact each other. Then, the mold halves 5, 6 are connected to each other by means of the sliding guides until they have reached their mutual final position or in particular the two wide sides 15, 16 extensively abut on top of each other. Hereby, the filament negative mold 8 formed by the grooves 9, 10 is closed. Then, the mold halves 5, 6 can be secured in their mutual relative position by inserting the filament piece 21 into the corresponding fixing openings 18, 19.

After positioning the ends 1, 2 of the filaments 3, 4 within the filament connector, then, it can be heated by an external heat source, here a flame 25 of a candle or a lighter or the like. Herein, the pipe body 13 of the filament negative mold 8 serves as a melting region 24 of the filament connector in the present case, in which the heat input is effected by means of the flame 25 or in the region of which the ends 1, 2 of the filaments 3, 4 are melted by the heat input. After melting, the two filament ends 1, 2 or the respective filaments 3, 4 are preferably slightly pressed towards each other towards the center or shifted into the channel 24, for example respectively by some millimeters, to ensure a secure connection of the filament ends 1, 2. Therein or afterwards, the filament ends 1, 2 are connected to each other by solidification of the melt of the filament materials of the two ends 1, 2.

Thus, the heat input of the flame 25 is not immediately effected into the filament ends 1, 2, but into the filament negative mold 8. In addition, the ends 1, 2 of the two filaments 3, 4 to be connected remain in place within the filament negative mold 8 during the heat input by means of the flame 25 and accordingly are correspondingly melted and the ends 1, 2 are connected to the then integral filament by solidification of the melt of the filament materials of the two filaments 3, 4 after termination of the heat input, for example by removing the flame 25.

After termination of the connection, the filament piece 21 for securing the two mold halves 5, 6 can then be removed and the two mold halves 5, 6 can be opened by a movement opposite to the sliding direction (arrow 17), to remove the then integral filament. By the configuration 10 or the filament negative mold 8, thus, it is ensured that the newly formed, integral filament has an at least substantially uniform or only slightly increased cross-section of for example 1.75 to 1.8 millimeters or of 2.85 to 3 millimeters, in consistent manner, thus in particular also in the connection region of the original ends 1, 2.

Since the filament connector can be completely removed subsequent to the connection, a new filament reel can be readily added to the end of a filament reel approximately printed to the end during a printing process. Thus, a connection of a new filament reel can also be achieved within a 3D printing process.

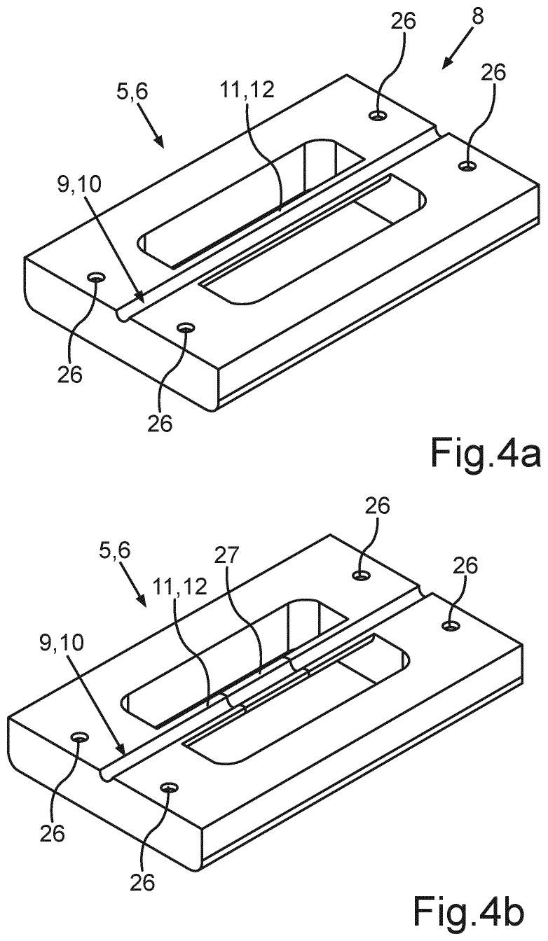

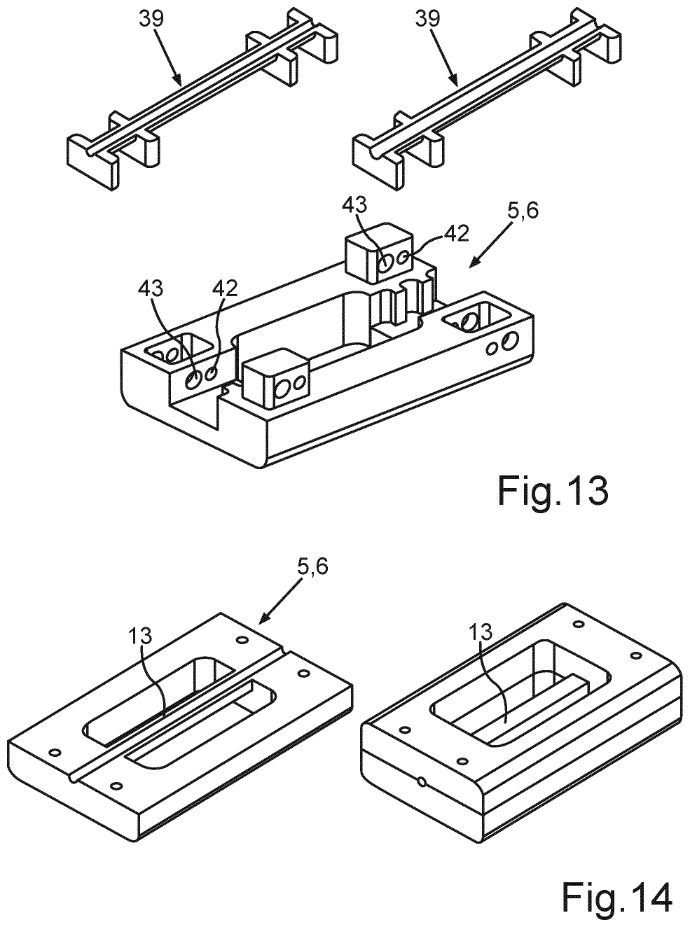

In FIGS. 4a and 4b, a second and a third embodiment of a respective mold half 5, 6 of a corresponding filament connector are illustrated. In contrast to the first embodiment, sliding guide elements 22, 23 are not provided herein, but rather openings 26 for connecting the respective mold halves 5, 6. Corresponding securing means can be passed through these openings 26 to mutually position the two mold halves 5, 6. This represents a simple embodiment. Alternatively, threaded openings can be provided. A magnetic solution, for example with two differently magnetized mold halves 5, 6 or magnets employed in the mold halves 5, 6, would also be conceivable. In order to prevent movements of the mold halves 5, 6 in relation to each other along the wide sides 15, 16 thereof, they could be solved with elevations similarly as explained afterwards in FIG. 13.

In contrast to the embodiment according to FIG. 4a, a respective length region 27 of the corresponding partial shell 11, 12 of the pipe body 13 is formed of another metal, for example of copper, in the embodiment according to FIG. 4b. Hereby, the melting region 24, in which the ends 1, 2 of the respective filaments 3, 4 are connected to each other, can be correspondingly influenced.

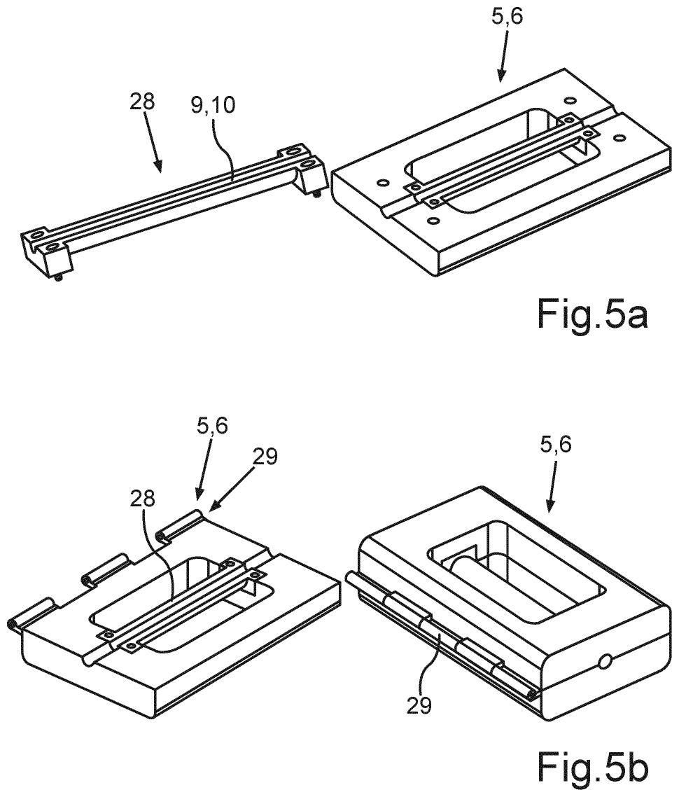

FIG. 5a shows a mold half 5, 6 of a mold connector according to a further embodiment in a perspective view, in which the respective partial shell 11, 12 of the pipe body 13 is formed as a separate insert part, which is for example fixed to the corresponding mold half 5, 6 by means of respective screws. By choice of the suitable respective insert part 28, thus, the cross-section of the pipe body 13 can be varied, for example between 1.75 and 2.85 millimeters, in order that filaments of different thicknesses can be connected to each other, according to which one of the insert parts 28 is currently employed. Accordingly, with the insert part for filaments of small diameter, filament ends of correspondingly small diameter can be connected to each other, with the insert part for filaments of large diameter, filament ends of large diameter can correspondingly be connected to each other. In particular, the respective insert part can also be connected to the respectively associated mold half 5, 6 by pressing/pressing-in or another connection technology. In addition, it would be conceivable to connect the respective insert part to the associated mold half 5, 6 by magnetic means. In this embodiment too, a magnetic connection of the mold halves 5, 6 analogously to the embodiment according to FIGS. 4a and 4b would be conceivable.

FIG. 5b shows a mold half 5, 6 for a filament connector according to a further embodiment in respective perspective views, in which the two mold halves 5, 6 are connected to each other via respective hinging means 29. Thus, the two mold halves 5, 6 can be particularly simply connected to each other and detached from each other, respectively. In this embodiment too, it would be possible to connect the respective insert part to the associated mold half 5, 6 by magnetic means. In addition, the mold halves 5, 6 could be magnetically fixed to each other after folding here too.

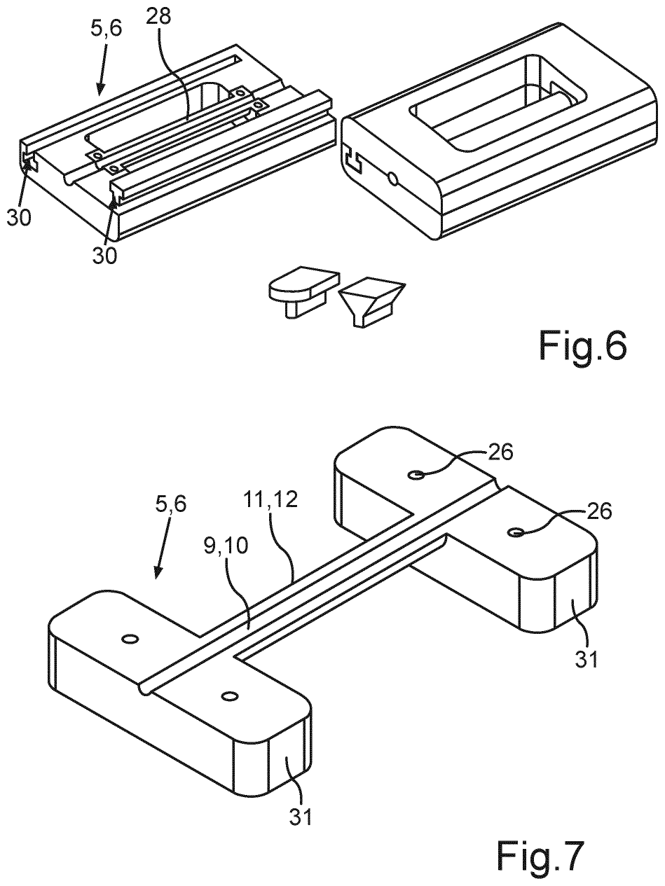

In FIG. 6, a further embodiment of the filament connector is shown in respective perspective views, but which substantially traces back to that embodiment according to FIG. 5a. Here too, a corresponding insert part 28 is provided, wherein the two mold halves 6 are to be connected to each other via respective form-fit sliding connections 30. Herein, the sliding connections 30 are formed as positive and negative molds, respectively, T-shaped and Y-shaped in cross-section, respectively, such that the two mold halves 5, 6 can be connected to each other and detached from each other, respectively, along the extension direction of the sliding guide means 30. In this embodiment too, the respective insert part 28 can be formed connectable to the associated mold half 5, 6 by magnetic means.

FIG. 7 shows a particularly simple embodiment in a further perspective view, in which the respective mold halves 5, 6 comprise respective, bar-like elements 31, between which the respective partial shells 11 and 12, respectively, extend. Within the bars 31 and the partial shells 11, 12, respectively, the respective grooves 9, 10 for forming the filament negative mold 8 are again introduced. In this embodiment too, a magnetic connection of the mold halves 5, 6 analogously to the embodiment according to FIGS. 4a and 4b would be conceivable.

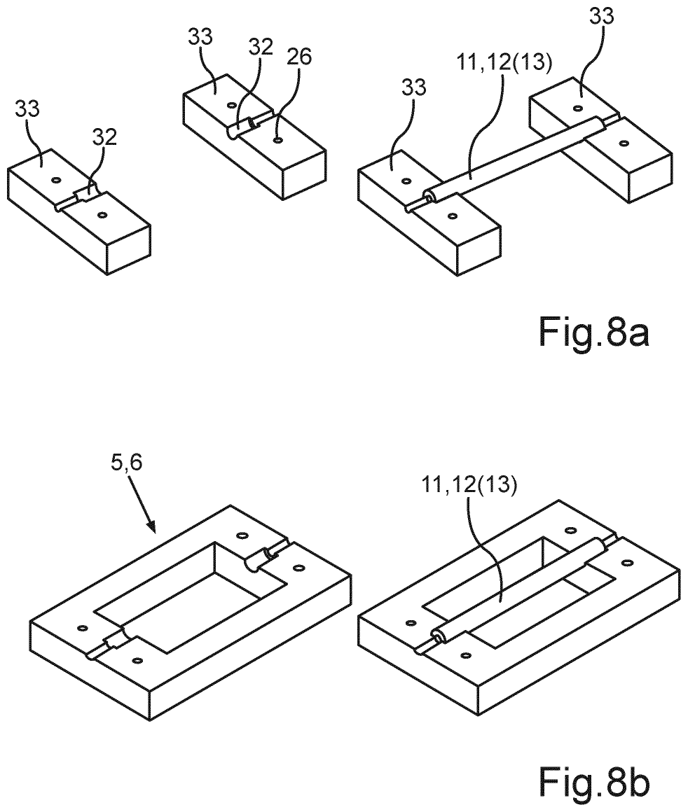

In FIGS. 8a and 8b, respective perspective views to further embodiments of the respective mold halves 5, 6 of corresponding filament connectors are illustrated. Therein, FIG. 8a traces back to that embodiment according to FIG. 7, wherein either a respective partial shell 11 and 12, respectively, or a pipe body 14 completely surrounding on the outer circumference is inserted into corresponding receptacles 32 of the elements 31 between the respective bar-like elements 31.

The embodiment according to FIG. 8b shows a respective mold half 5, 6 in a perspective view, which traces back to that according to FIG. 5a in its basic construction. Here too, a respective rectangular frame shape is selected for each of the mold halves 5, 6, with corresponding receptacles 33, into which respectively associated partial shells 11, 12 or a complete pipe body 13 can again be inserted.

Also in the embodiments according to FIGS. 8a and 8b, a magnetic connection of the mold halves 5, 6 analogously to the embodiment according to FIGS. 4a and 4b would be conceivable.

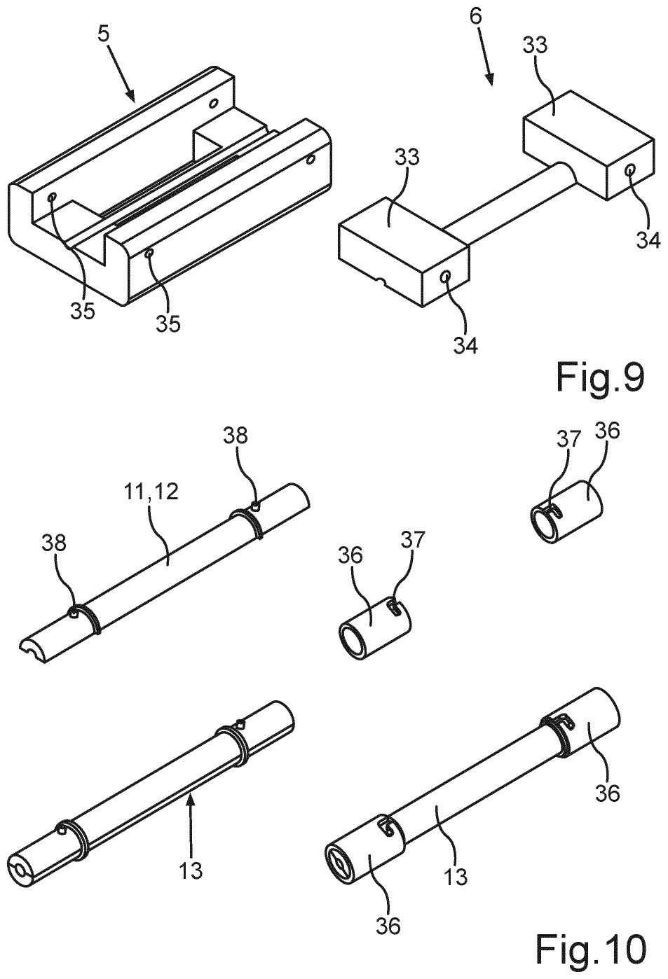

FIG. 9 shows an embodiment of the filament connector, in which the two mold halves 5, 6 are differently formed. Herein, the one mold half 5 is substantially U-shaped configured and formed for receiving the other mold half 6, which comprises two bar-like elements 33, between which a partial shell 12 extends, which can be assembled to the partial shell 11 extending on the side of the U-shaped mold half 5 in that the two mold halves 5, 6 are connected to each other. Herein, respective openings 34 are provided in the bar-like elements 33, which cooperate with fixing openings 35 in the mold half 5 such that the two mold halves 5, 6 can be fixed to each other in a corresponding relative position.

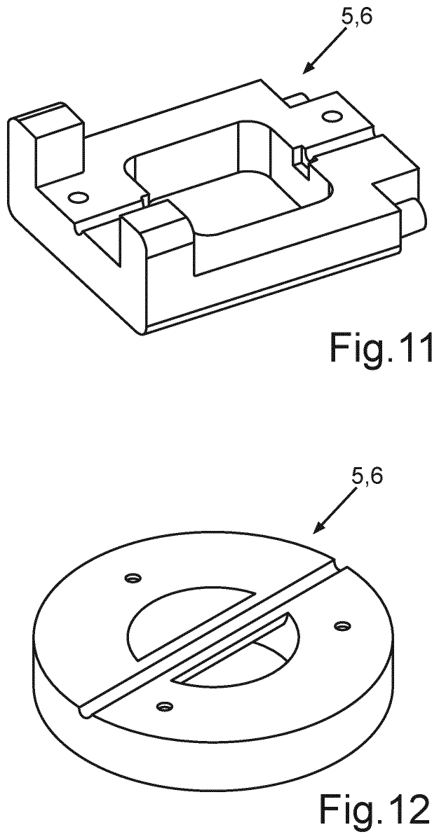

In FIG. 10, a pipe body 13 formed as an insert part according to a further embodiment of the filament connector according to the invention is illustrated in respective perspective views. Therein, the pipe body 13 again comprises two partial shells 11, 12, which are assembled to each other and connected to each other by respective pipe sockets 36, which are fitted onto the pipe body 13 on the end side by means of respective bayonet guides 37, which cooperate with corresponding studs 38 on the side of the partial shells 11, 12. By the bayonet guide 37, which cooperates with the studs 38, thus, the two partial shells 11, 12 can be connected to each other. In addition, the pipe sockets 36 serve for arrangement within respective receptacles 33, as they are for example illustrated in the embodiments according to FIGS. 8a and 8b.

In FIG. 11, a further embodiment of a mold half 5, 6 for a filament connector according to the invention is illustrated in a corresponding perspective view. This filament connector for example has a smaller fit, into which a pipe body 13 for example explained in context of FIG. 10 can be inserted. In this embodiment too, it would be possible to connect the respective insert part to the associated mold half 5, 6 by magnetic means.

In FIG. 12, a respective mold half 5, 6 is illustrated in a perspective view, which is at least substantially circularly formed in contrast to the preceding embodiments. Otherwise, the present filament connector is formed similarly to that according to FIG. 4a.

In FIG. 13, a mold half 5, 6 according to a further embodiment of the filament connector is illustrated, which can be assembled to an identical mold half 5, 6. Therein, an insert part 39 can be inserted into each of the mold halves 5, 6, the respective groove 9, 10 of which is selectively matched to a thin filament or a thick filament. Herein, respective fixing openings 42 (small), 43 (large) in different diameters are already present, always suitable for the selected insert part 39. Alternatively, it would be possible in this embodiment too to connect the respective insert part to the associated mold half 5, 6 by magnetic means.

FIG. 14 shows a mold half 5, 6 and a filament connector, respectively, which at least substantially corresponds to that one according to FIG. 4a. In contrast to the embodiment according to FIG. 4a, however, the pipe body 13 is rectangularly formed in cross-section on the outer circumference.

In the embodiments according to FIGS. 12 to 14 too, a magnetic connection of the mold halves 5, 6 analogously to the embodiment according to FIGS. 4a and 4b would be conceivable.

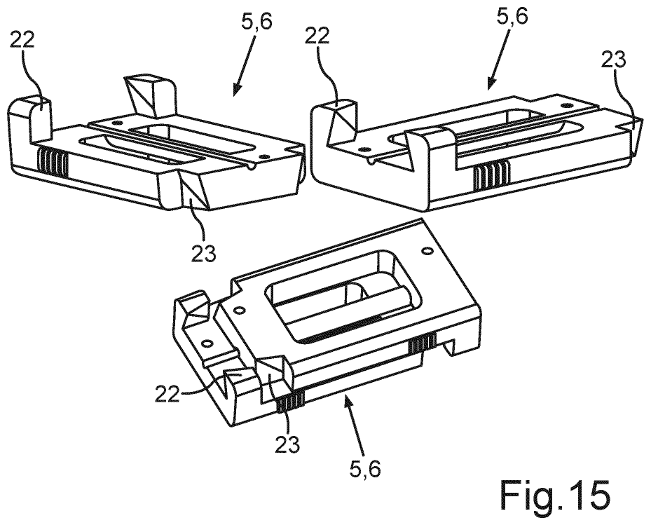

In FIG. 15, a respective mold half 5, 6 and a filament connector, respectively, are illustrated in respective perspective views, which at least substantially corresponds to that one according to the first embodiment. In contrast to the first embodiment, however, sliding guide elements 22, 23 are presently provided, which allows a dovetail-shaped guidance of the two mold halves 5, 6.

Presently, all of the partial shells 11, 12 and pipe bodies 13 of the filament negative mold 8, respectively, are formed of a metal material either integrally with the respective mold half 5, 6 or separately thereof. This allows a homogeneous heating and solidification of the filament materials of the two filament ends 1, 2.

The mold halves 5, 6 as well as partial shells 11, 12 and pipe bodies 13 of the filament negative mold 8, respectively, are preferably formed of a stainless steel material and provided with a structure in the form of a transparent chromium oxide layer. Hereby, the said components can preferably be stained black to ensure an optically beneficial appearance of the filament connector even with frequent heating by means of the flame 25.

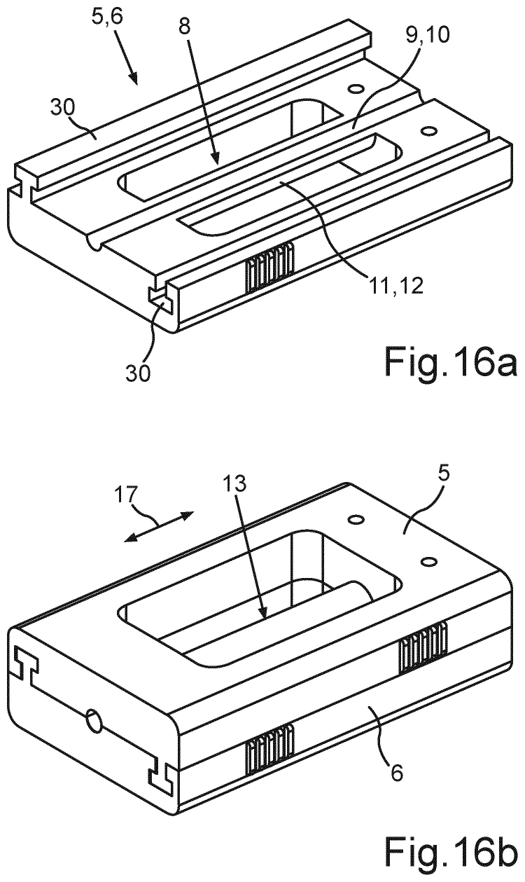

FIGS. 16a and 16b show a mold half 5, 6 and both assembled mold halves 5, 6, respectively, of the filament connector according to a further embodiment in respective perspective views, which basically corresponds to that according to FIG. 6. However, a separate insert part is presently not provided. Rather, the two partial shells 11, 12 are presently formed integrally with the respective mold element or the respective mold half 5, 6. Thus, the two partial shells 11, 12 are again formed as respective half pipes, which have the opening formed as a groove 9 and 10, respectively, in the interior. In the assembled state of the two mold halves 5, 6, the partial shells 11, 12 thus again form the pipe body 13 apparent in FIG. 16b, which is an essential part of the filament negative mold 8. For the rest, the filament negative mold is formed by those length regions of the respective grooves 9, 10, which extend to the respective partial shells 11, 12 towards the outside up to the narrow sides of the respective mold elements or mold halves 5, 6.

Analogously to the embodiment according to FIG. 6, the two mold halves 5, 6 at least substantially formed identical in shape can be connected to each other via respective form-fit sliding connections 30 here too. Herein, the sliding connections 30 are again formed as positive and negative molds, respectively, T-shaped in cross-section such that the two mold halves 5, 6 can be connected to each other and detached from each other, respectively, along the extension direction of the sliding guide means 30 or along the sliding direction 17.

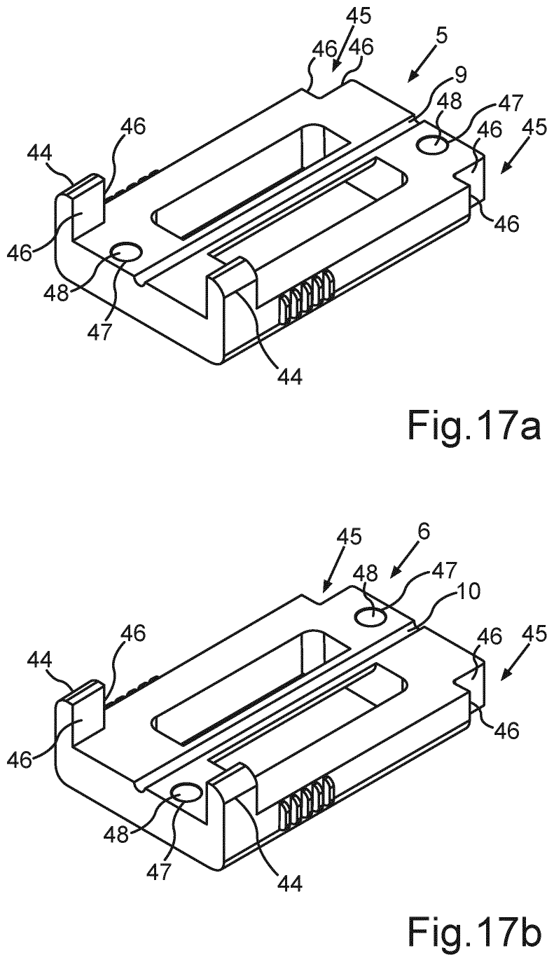

In context of FIGS. 17a to 21, two further embodiments of the filament connector according to the invention are to be explained afterwards, which are substantially identically formed with respect to their basic shape. These two filament connectors are at least substantially identically formed with respect to their basic shape—with the exception of the respective sliding guide elements—like the embodiment according to FIGS. 1 to 2c, such that reference is insofar made to the explanations in this respect and special characteristics are in particular addressed afterwards.

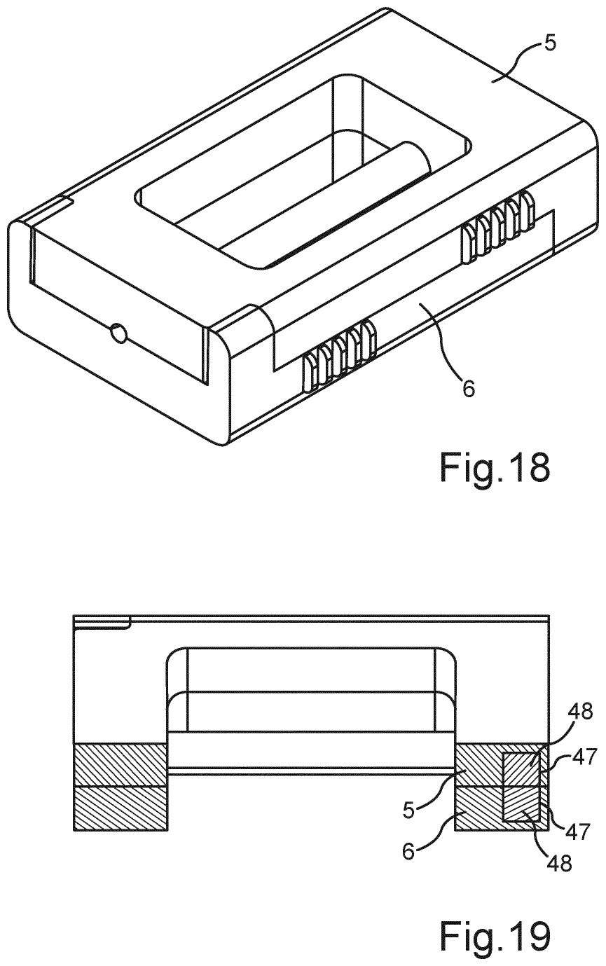

Here too, the mold halves 5, 6 have a respectively substantially rectangular basic contour, which surrounds a central opening 7. Within the mold elements 5, 6, a filament negative mold 8 is formed in that a gutter-like groove 10 semicircular in cross-section is respectively formed. This groove 9 and 10, respectively, is formed by a respective mold part in the form of a partial shell 11, 12 dividable in extension direction of the respective filament 3, 4 in the region of the central opening 7, which is presently formed integrally with the respective mold element or the respective mold half 5, 6. The two mold elements 6 again have respective wide sides or separating surfaces 15, 16, on which the two mold elements 5, 6 flatly abut on each other in the assembled state according to FIG. 18.

As is in particular apparent based on FIGS. 17a and 17b in respective perspective views to the two mold halves 5, 6, the respective mold element 5, 6 comprises respective stud-like sliding guide elements 44, which protrude or project with respect to the separating surface/wide side 15, 16 of the mold element 5, 6 towards the respectively other mold element 5, 6, in which a respectively corresponding stud receptacle 45 for receiving the stud-like sliding guide elements 45 is recessed. Accordingly, each two stud receptacles 45 of the one mold element 5, 6 serve for receiving each two stud-like sliding guide elements 44 of the other mold element 5, 6. Therein, both the stud-like sliding guide elements 44 and the stud receptacles 45 are at least substantially rectangular in cross-section—related to a sectional plane extending parallel to the wide sides or separating surfaces 15, 16. Here, other shapes would optionally also be conceivable.

Therein, the respective sliding guide elements 44, which substantially perpendicularly protrude from the corresponding wide sides 15, 16, and the respective stud receptacles of the mold elements 5, 6 comprise respective guide and stop surfaces 46, along which the mold elements 5, 6 can be shifted and positioned in relation to each other in a direction parallel to the wide sides 15, 16 and in a direction perpendicular to the wide sides 15, 16. Hereby, the mold elements 5, 6 formed separately from each other can be manually assembled without problem and connected to each other such that the two mold elements 5, 6 come into mutual overlap and flatly abut on each other in the region of the separating surfaces/wide sides 15, 16.

As is in particular apparent from FIGS. 17a and 17b, respective receiving openings 47 for fixing means extending transversely—and in particular perpendicularly—to the separating surfaces/wide sides 15, 16 of the mold elements 5, 6 for mutually fixing the mold elements 6 are introduced into the respective mold elements 5, 6.

In the embodiment according to FIGS. 17a to 19, respective magnetic elements 48 are received in these receiving openings 47, which are for example cylindrically formed and inserted into the receiving openings by adhering or the like. Herein, the receiving openings 47 are for example formed as blind holes open to the wide sides 15, 16. If the two mold elements 5, 6 according to FIG. 18 are connected to each other, thus, the magnetic elements 48 are in overlap to each other in the region of the wide sides 15, 16 of the two mold elements 5, 6 and thus provide that the two mold elements 5, 6 are fixed to each other as a result of the magnetic force mutually exerted on each other by the magnetic elements 48, such that the connection of the ends 1, 2 of the filaments 3, 4 can now be begun. Therein, the mutual position of the magnetic elements 48 in the region of the wide sides 15, 16 of the two mold elements 5, 6 in overlap to each other is in particular apparent from FIG. 19, which shows a section through the filament connector in the region of a pair of magnetic elements 48.

For example, neodymium bar magnets with a diameter of 4 mm and a length of 5 mm are employed as magnetic elements 48, which are for example zinc-plated or nickel-plated and sticked-in in recessed manner.

After termination of the connection of the ends 1, 2 of the filaments 3, 4, the two mold elements 5, 6 can then again be detached from each other by manually actuating and overcoming the magnetic forces. Herein, the guide and stop surfaces 46 of the respective sliding guide elements 44 and of the associated stud receptacles 45 serve for easier separation of the two mold halves 5, 6.

As is furthermore apparent from FIGS. 17a and 17b, the receiving openings 47 of the respective mold element 5, 6 are introduced on opposite sides of the respectively associated groove 9, 10. With the exception of these receiving openings 47, both mold halves 5, 6 are formed identical in shape. This means that the two mold elements 5, 6 are formed identical in shape with respect to their basic shape, which is formed by the frame-like basic configuration and the sliding guide elements 46 and the corresponding stud receptacles 45 thereof. Hereby, both mold elements 5, 6 can be uniformly manufactured with the exception of the introduction of the receiving openings 47.

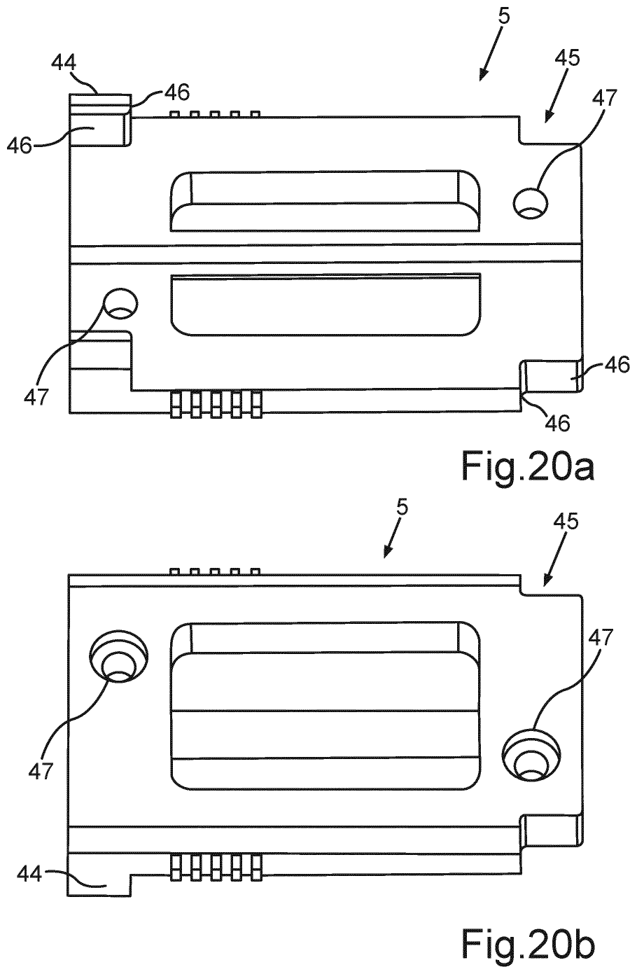

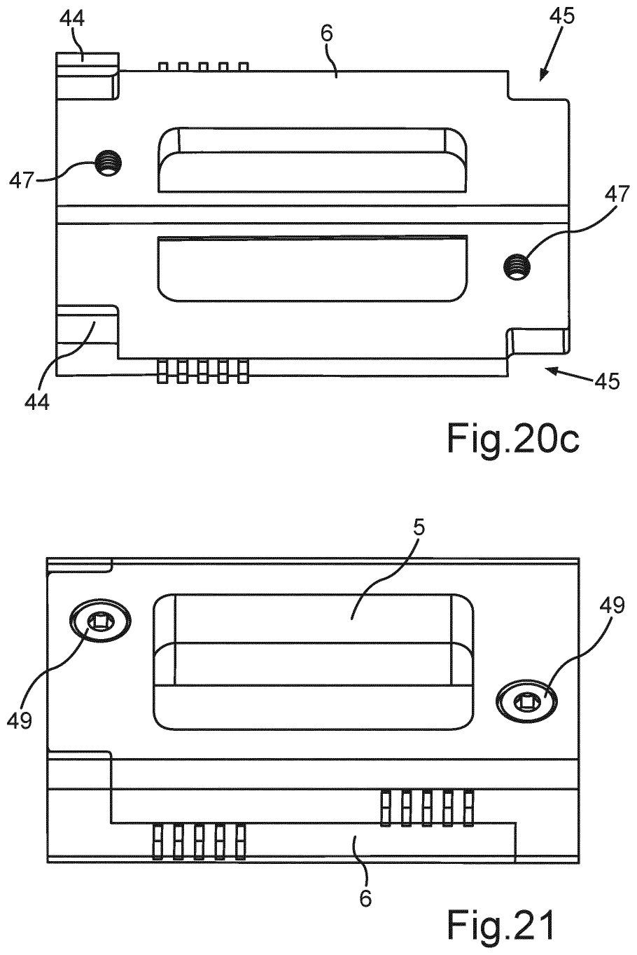

The embodiment according to FIGS. 20a to 21 is formed substantially identically to that according to FIGS. 17a to 19; only the receiving openings 47 are differently configured in order that the two mold elements 5, 6 can be connected to each other by mechanical connecting elements 49 in the form of screws. Accordingly, the one mold element 5 according to FIGS. 20a and 20b is provided with receiving openings in the form of continuous countersunk holes 47 and the mold element 6 according to FIG. 20c is provided with receiving openings in the form of threaded holes such that the two mold elements 5, 6 can be connected to each other with respective screws apparent in FIG. 21 as mechanical connecting elements 49. Instead of the screws employed here, any other screw elements can of course also be employed.

In particular, the respective groove 9, 10 for forming the filament negative mold 8 is presently provided with a non-stick coating of polytetrafluoroethylene (PTFE). For attaching this coating to the mold element 5, 6 produced of a stainless steel material, the groove 9, 10 is roughened by sand blasting.

Herein, different methods are conceivable:

Either, the entire respective mold element 5 or 6 is roughened by sand blasting or a similar method and subsequently the PVD coating (PVD=physical vapor deposition), for example of titanium aluminum nitride, is first applied to the entire mold element 5, 6, whereafter the region of the grooves 9, 10 is provided with the PTFE coating.

Or the mold elements 5, 6 are by a PVD coating, for example of titanium aluminum nitride, and subsequently the mold elements 5, 6 are roughened in the region of the grooves 9, 10 and provided with the PTFE coating.

Alternatively to the PVD coating, other methods for staining the mold elements 5, 6 are also conceivable. Herein, DLC coating (DLC=diamond like carbon), thus an amorphous carbon coating, is for example possible. In addition, fire-resistant paints or varnishes or the like coatings or high-temperature paints or varnishes would also be conceivable. Staining of the mold elements 5, 6 is also conceivable by a burnishing agent or by plasma nitration with subsequent post-oxidation and interference coating, for example with a chromium oxide coating.

### LIST OF REFERENCE CHARACTERS

1 End

2 end

3 filament

4 filament

5 mold element

6 mold element

7 opening

8 filament negative mold

9 groove

10 groove

11 partial shell

12 partial shell

13 pipe body

14 channel

15 wide side

16 wide side

17 arrow (sliding direction)

18 fixing opening

19 fixing opening

20 chamfer

21 filament piece

22 sliding guide element

23 sliding guide element

24 melting region

25 flame

26 openings

27 length region

28 insert part

29 hinging means

30 sliding guides

31 bar-like elements

32 receptacles

33 bar-like elements

34 fixing opening

35 fixing opening

36 pipe socket

37 bayonet guides

38 stud

39 insert part

40 corrugation

41 corrugation

42 fixing openings

43 fixing openings

44 sliding guide elements

45 stud receptacles

46 stop surfaces

47 receiving openings

48 magnetic elements

49 connecting elements

1. A filament connector for connecting respective ends of filaments for the additive manufacture of a three-dimensional object in a fused filament fabrication, with at least two mold elements capable of being assembled and with a filament negative mold, in which the ends of the filaments previously melted in a melting region of the filament connector can be connected to each other by solidification of the melt of the filament materials of the two ends,
wherein the filament negative mold forms the melting region of the filament connector, within which the ends of the filaments can be melted by heat input and can be connected to each other by solidification of the melt of the filament materials of the two ends.

2. The filament connector according to claim 1,
wherein the filament negative mold is formed of metal material.

3. The filament connector according to claim 1,
wherein the filament negative mold is formed of a plurality of mold parts, in particular partial shells dividable in an extension direction of the filament.

4. The filament connector according to claim 1,
wherein the mold elements of the filament connector can be assembled to each other by respective sliding guide elements.

5. The filament connector according to claim 4,
wherein the respective sliding guide elements of the mold elements of the filament connector conically cooperate with each other upon assembling.

6. The filament connector according to claim 1,
wherein the mold elements of the filament connector comprise respective fixing openings arranged at least in partial overlap to each other with assembled mold elements, into which a securing means can be inserted.

7. The filament connector according to claim 6,
wherein respective centers of the fixing openings cooperating with each other in the corresponding mold elements have an offset to each other.

8. The filament connector according to claim 1,
wherein the mold elements and the associated mold part of the filament negative mold are respectively integrally formed.

9. The filament connector according to claim 1,
wherein the filament negative mold is formed for heating by means of a flame.

10. The filament connector according to claim 1,
wherein the filament negative mold is formed as an insert part exchangeable in the filament connector.

11. The filament connector according to claim 4,
each mold element comprises respective, stud-like sliding guide elements, which protrude with respect to a separating surface towards the other mold element in which stud receptacles for receiving the stud-like sliding guide elements are recessed.

12. The filament connector according to claim 11,
wherein the respective sliding guide elements and the respective stud receptacles of the mold elements comprise respective guide and stop surfaces, along which the mold elements can be positioned in relation to each other.

13. The filament connector according to claim 11,
wherein respective receiving openings for fixing means extending transversely to the separating surfaces of the mold elements for mutually fixing the mold elements are introduced into the respective mold elements, in which magnetic elements or mechanical connecting elements are arranged.

14. The filament connector according to claim 13,
wherein the receiving openings of the respective mold element are introduced on opposite sides of the respectively associated groove.

15. The filament connector according to claim 1,
wherein basic shapes of the two mold halves are formed identical in shape.
